(19) United States
(12) Patent Application Publication
(10) Pub. No.: US 2013/0195310 A1
(43) Pub. Date: Aug. 1, 2013

(54) EARPHONE WITH FIXING FUNCTION AND EARPLUG THEREOF

(71) Applicant: PI-FEN LIN, TAIPEI CITY (TW)

(72) Inventor: PI-FEN LIN, TAIPEI CITY (TW)

(21) Appl. No.: 13/826,256

(22) Filed: Mar. 14, 2013

Related U.S. Application Data
(63) Continuation-in-part of application No. 12/691,446, filed on Jan. 21, 2010, now abandoned.

(51) Int. Cl. H04R 1/10

(52) U.S. Cl. CPC H04R 1/105
USPC 381/380

(57) ABSTRACT

An earphone with fixing function includes an earphone housing having a holding portion and an earplug sleeved around the holding portion. The earplug has a sleeving portion, a fixing portion and an abutting portion. The fixing portion extended from a periphery of the sleeving portion has an arm portion and a jamming portion. One end of the arm portion is fixed on the sleeving portion and the other end of the arm portion is bent and extended to form the jamming portion.

### CROSS-REFERENCE TO RELATED APPLICATIONS

This Application is a Continuation-in-Part of application Ser. No. 12/691,446, filed Jan. 21, 2010, now pending, and entitled “EARPHONE WITH FIXED FUNCTION AND EARPLUG WITH FIXED FUNCTION”.

### BACKGROUND OF THE INVENTION

1. Field of the Invention

The present invention relates to an earphone and an earplug, in particular, to the earphone with fixing function and the earplug thereof.

2. Description of Related Art

With the rapid development of portable multimedia devices or stereo equipments, earphones such as traditional earphones or Bluetooth earphones have been widely used.

Referring to FIG. 1, a traditional earbud-type earphone includes an earphone housing 1a and an earplug 2a. The earphone housing 1a has a speaker 11a correspond to user's ear canal and the earplug 2a is sleeved around the speaker 11a. The earplug 2a and the speaker 11a are inserted into the user's ear canal and the user can listen to the audio sound produced by the speaker 11a.

However, the speaker 11a sleeved with the earplug 2a must be inserted into the user's ear canal for listening. The size of the earplug 2a usually not mates with the size of the user's ear canal. If the earplug 2a is too large, the user will feel uncomfortable. If the earplug 2a is too small, the speaker 11a will be too loose in the user's ear canal such that the earphone housing 1a is easy to dislodge from the user's ear.

### SUMMARY OF THE INVENTION

In view of the aforementioned issues, the present invention provides an earphone with fixing function. The earphone can mate with a pinna of user's ear, so as to the earphone can comfortably and stably secure to the pinna of the user's ear and can increase stereo of a speaker.

To achieve the above-mentioned objectives, the present invention provides an earphone with fixing function including an earphone housing having a holding portion and an earplug sleeved around the holding portion. The holding portion is formed with a sound passageway for transmitting audible sound. The earplug has a sleeving portion, a fixing portion, an abutting portion, a sealed portion, and abutting portion. The fixing portion is protrudingly extending from a periphery of the sleeving portion, and includes an arm portion and a jamming portion. The arm portion is extended from the sleeving portion and connected with the jamming portion. The sealed portion is extended from one side of the sleeving portion substantially perpendicular to the fixing portion. The abutting portion is outwardly protruding from the sleeving portion along a direction substantially opposite to the fixing portion away from a wearer's face and arranged immediately adjacent to the holding portion

Therefore, the sealed portion and the fixing portion can be properly deformed according to the profile of the pinna of user's ear. The earphone housing can be comfortably secured to the user's ear without putting the earplug into the ear canal, so as to avoid a tingle and a bacterial infection in the user's ear.

Moreover, the sealed portion fits the pinna outside the ear canal and the fixing portion jams the upper cartilage and the lower cartilage of the pinna of the user's ear, so as to constitute a function of supporting and fixing for making the holding portion not be too loose in the user's ear such that the earplug will not dislodge from user's ear.

Further, the holding portion is inserted into the sleeved hole and be positioned in the sealed space such that the sealed portion encircles the holding portion for increasing stereo.

In order to further understand the techniques, means and effects the present invention takes for achieving the prescribed objectives, the following detailed descriptions and appended drawings are hereby referred, such that, through which, the purposes, features and aspects of the present invention can be thoroughly and concretely appreciated; however, the appended drawings are provided solely for reference and illustration, without any intention that they be used for limiting the present invention.

### BRIEF DESCRIPTION OF THE DRAWINGS

FIG. 1 is a schematic view of the traditional earphone according to the prior art;

FIG. 2A is a exploded view of earphone with fixing function of the present invention;

FIG. 2B is another exploded view of earphone with fixing function of the present invention;

FIG. 3 is a assembled view of earphone with fixing function of the present invention;

FIG. 4 is a cross-sectional view of earphone with fixing function of the present invention;

FIG. 5A is a top view of the fixing portion of the earphone with fixing function according to the first embodiment of the present invention;

FIG. 5B is a top view of the fixing portion of the earphone with fixing function according to the second embodiment of the present invention;

FIG. 5C is a top view of the fixing portion of the earphone with fixing function according to the third embodiment of the present invention;

FIG. 5D is a top view of the fixing portion of the earphone with fixing function according to the fourth embodiment of the present invention;

FIG. 5E is a top view of the fixing portion of the earphone with fixing function according to the fifth embodiment of the present invention;

FIG. 5F is a top view of the fixing portion of the earphone with fixing function according to the sixth embodiment of the present invention;

FIG. 5G is a top view of the fixing portion of the earphone with fixing function according to the seventh embodiment of the present invention;

FIG. 6 is a using-state side view of earphone with fixing function of the present invention;

FIG. 6A is a using-state front view of earphone with fixing function of the present invention;

FIG. 7A is a top view of the earphone housing of the earphone with fixing function according to the eighth embodiment of the present invention;

FIG. 7B is a top view of the earphone housing of the earphone with fixing function according to the ninth embodiment of the present invention; and

FIG. 7C is a top view of the earphone housing of the earphone with fixing function according to the tenth embodiment of the present invention.

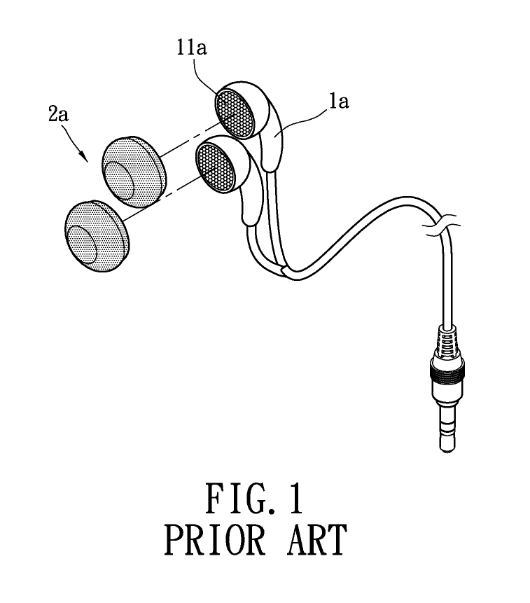

### DETAILED DESCRIPTION OF THE PREFERRED EMBODIMENTS

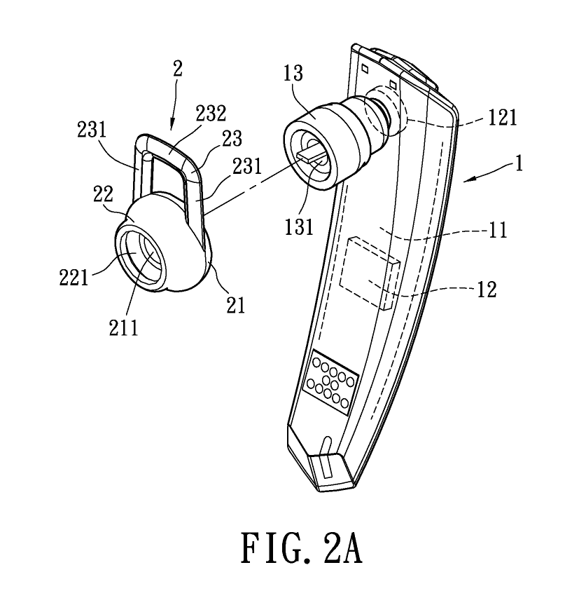

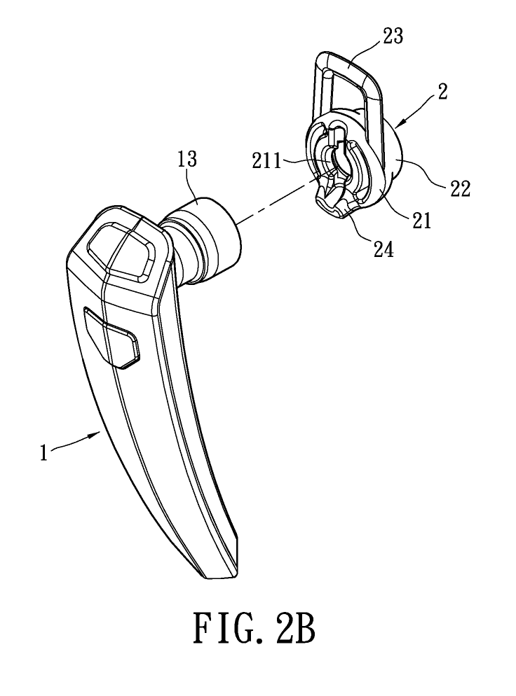

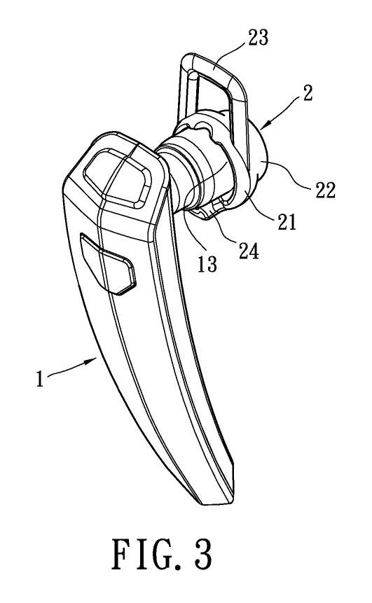

Referring to FIGS. 2A, 2B, and 3, the first embodiment of the present invention provides an earphone with fixing function including an earphone housing 1 and an earplug 2.

The earphone housing 1 has an accommodating space 11, a signal receiver 12, and a holding portion 13. The accommodating space 11 is disposed within the earphone housing 1 for receiving the signal receiver 12 and a speaker 121. The holding portion 13 has a sound passageway 131 which is connected with the accommodating space 11. The signal receiver 12 can pick up electrical signals which are generated from players, computers, mobile phones, telephones or other electronic products via transmission line, Bluetooth, infrared, or other wired or wireless signal transmitter. The signal receiver 12 can translate electronic signals to audible sound and transmit the same to the speaker 121 such that the audible sound passes through the sound passageway 131. However, the signal receiver 12 is a commonly known electronic component and does not rehearse it here.

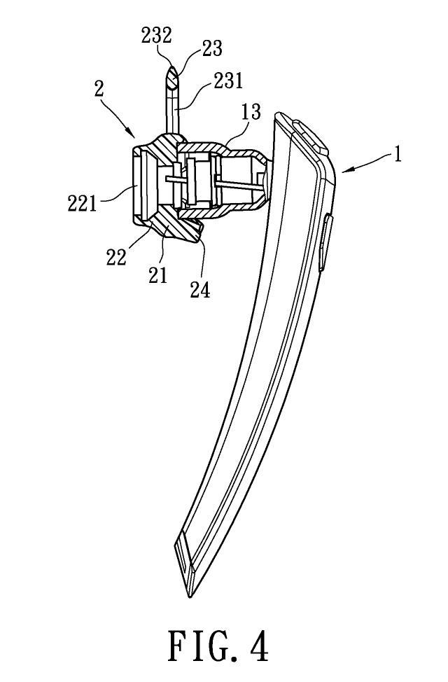

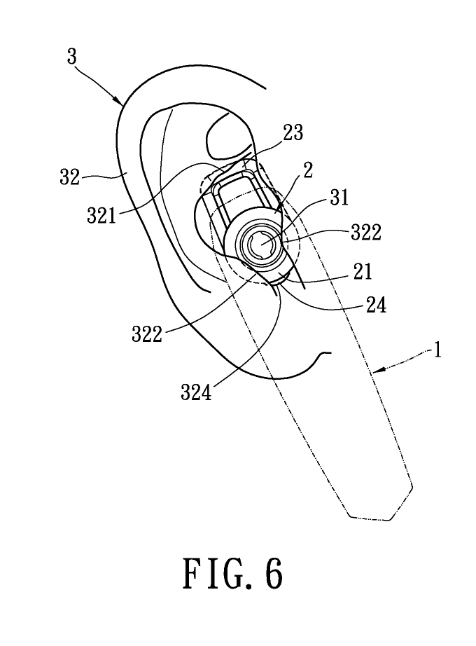

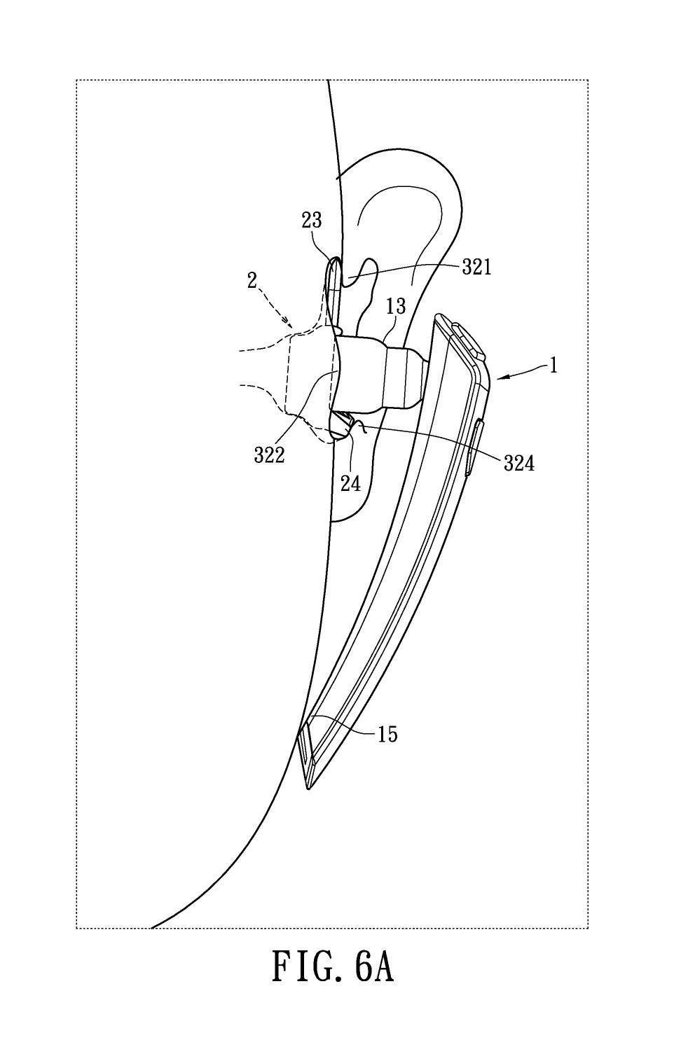

The earplug 2 has a sleeving portion 21, a sealed portion 22, a fixing portion 23 and an abutting portion 24. The sealed portion 22 is extended from one side of the sleeving portion 21. The fixing portion 23 is extended from a periphery of the sleeving portion 21. The abutting portion 24 is extended from the periphery of the sleeving portion 21 along a direction substantially opposite to the fixing portion 23, and is protruding from the sleeving portion 21 rather than from the wearer's face. Therefore, the abutting portion 24 can be rested on a lower concave area of human's ear, or called as “intertragic”, as shown in FIG. 6. The sleeving portion 21 has a sleeved hole 211 penetrated through the sleeving portion 21. When the sleeving portion 21 sleeves around the holding portion 13 of the earphone housing 1, the holding portion 13 is inserted into the sleeved hole 211 such that the sleeving portion 21 presses holding portion 13 for achieving a fixing effect. The sealed portion 22 protrudes from a surface of the sleeving portion 21 and has a sealed space 221 connected with the sleeved hole 211. The holding portion 13 be inserted into the sleeved hole 211 and be positioned in the sealed space 221 (as shown in FIG. 4) so that the sealed portion 22 encircles the holding portion 13 for increasing stereo. The fixing portion 23 has an arm portion 231 and a jamming portion 232. One end of the arm portion 231 is fixing on the sleeving portion 21, and the other end of the arm portion 231 is bent and extended to form the jamming portion 232.

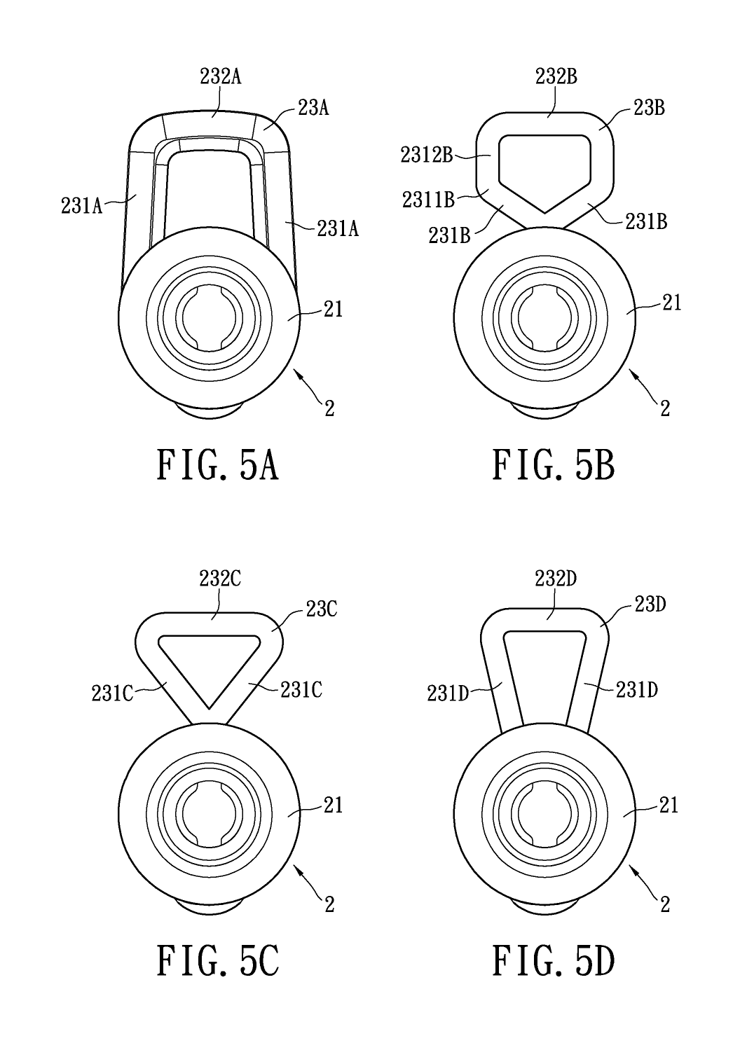

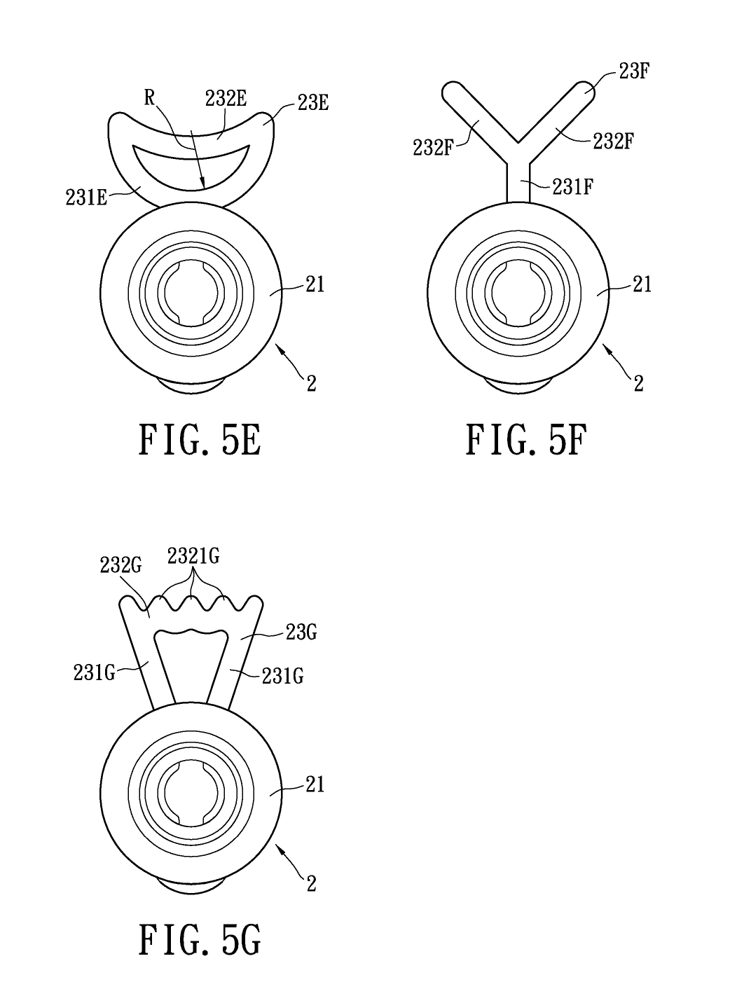

Referring to FIG. 5A, the first embodiment of the present invention. The fixing portion 23A has two arm portions 231A. One ends of the arm portions 231A are fixing on the sleeving portion 21 and are parallelly spaced at an interval. The other ends of the arm portions 231A are respectively connected with two ends of the jamming portion 232A. The two arm portions 231A and the jamming portion 232A constitute a rectangular geometry profile. Further, the fixing portion 23A may have different designs shown in FIGS. 5B to 5G.

Referring to FIG. 5B, the second embodiment of the present invention. The fixing portion 23B has two arm portions 231B. Each arm portion 231B has a first arm 2311B and a second arm 2312B. One end of the first arm 2311B is fixing on the sleeving portion 21, and is outwardly and slantly extended to form the other end of the first arm 2311B. One end of the second arm 2312B is connected with the other end of the first arm 2311B and is inwardly and slantly extended to form the other end of the second arm 2312B. The other ends of the second arms 2312B of the two arm portions 231B are respectively connected with two ends of jamming portion 232B. The two arm portions 231B and the jamming portion 232B constitute a pentagonal or above polygon geometry profile.

Referring to FIG. 5C, the third embodiment of the present invention. The fixing portion 23C has two arm portions 231C. One ends of the arm portions 231C converge at a point of the sleeving portion 21, and extend radially from the point to form the other ends of the arm portions 231C which are respectively connected with two ends of jamming portion 232C. The two arm portions 231C and the jamming portion 232C constitute a triangle geometry profile.

Referring to FIG. 5D, the fourth embodiment of the present invention. The fixing portion 23D has two arm portions 231D. One ends of the arm portions 231D are fixing on the sleeving portion 21 and spaced at an interval. The other ends of the two arm portions 231D are slantly extended along opposite direction to each other and are respectively connected with two ends of the jamming portion 232D. The two arm portions 231D and the jamming portion 232D constitute a ladder geometry profile.

Referring to FIG. 5E, the fifth embodiment of the present invention. The fixing portion 23E has an arm portion 231E with a radius of curvature R. A middle portion of the arm portion 231E is fixing on the sleeving portion 21 and is outwardly bent to form two ends of the arm portion 231E which are respectively connected with two ends of the jamming portion 232E. The arm portion 231E and the jamming portion 232E constitute a half-moon geometry profile.

Referring to FIG. 5F, the sixth embodiment of the present invention. The fixing portion 23F has an arm portion 231F and two jamming portions 232F. One end of the arm portion 231F is fixing on the sleeving portion 21 and the other end of the arm portion 231F is connected with one ends of the two jamming portions 232F.

Referring to FIG. 5G, the seventh embodiment of the present invention. The fixing portion 23G has two arm portions 231G and a jamming portion 232G with a plurality of ratchets 2321G One ends of the arm portions 231G are fixing on the sleeving portion 21 and spaced at an interval. The other ends of the two arm portions 231G are respectively connected with two ends of the jamming portion 232G. The ratchets 2321G are continuous wave-like protrudingly arranged on the jamming portion 232G and are arranged between the two arm portions 231G. As traditional Chinese medicine dictates, a human ear is one of the organs that contain the most concentrated acupuncture points (acupoints). In addition to providing secure retention, the ratchet structure (as illustrated in FIG. 5G) of the instant disclosure provides additional stimulation to the numerous acupoints in a user's ear.

Otherwise, a middle portion of the fixing portion 23, 23A, 23B, 23C, 23D, 23E, 23F, 23G can be solid body for achieving the same effect.

Referring to FIG. 6 and FIG. 6A, when the earplug 2 is secured to the user's ear 3, the sealed portion 22 can be properly deformed correspond to the profile of the pinna 32 outside the ear canal 31 and can be close connect with the pinna 32 for increasing fitness and comfort of contacting. Otherwise, the sealed space 221 and the ear canal 31 encircle a sealed space without gaps between the sealed space 221 and the ear canal 31, so as to increase stereo of speaker 121.

When the sealed portion 22 fits the pinna 32, the arm portions 231 of the fixing portion 23 can be properly deformed correspond to the profile of the pinna 32. The jamming portion 232 of the fixing portion 23 jams an upper cartilage 321 of the pinna 32 due to a elastic force produced by the deformed arm portions 231. Two sides of the sleeving portion 21 are blocked by a pair of cartilages 322 (or called as tragus and antitragus). The abutting portion 24 abuts a lower edge of the lower concha of the pinna 32, or called as intertragic 324, for supporting and fixing, so as to make the holding portion 13 not be too loose in the user's ear 3 such that the earplug 2 will not dislodge from user's ear 3. Further, the earphone housing 1 has a lower end 15 abutted against a face of user. The present invention can achieve a well wearing result fixing in the user's ear 3. The present invention has at least three points fixing to the user's ear 3. First point, the fixing portion 23 is blocked by upper cartilage 321 of the pinna 32; second point, the sleeving portion 21 is blocked by the pair of cartilages 322; and third point, the abutting portion 24 is rested on the intertragic 324. Moreover, the earphone housing 1 has a lower end 15 rested on user's face, which makes a more stable result.

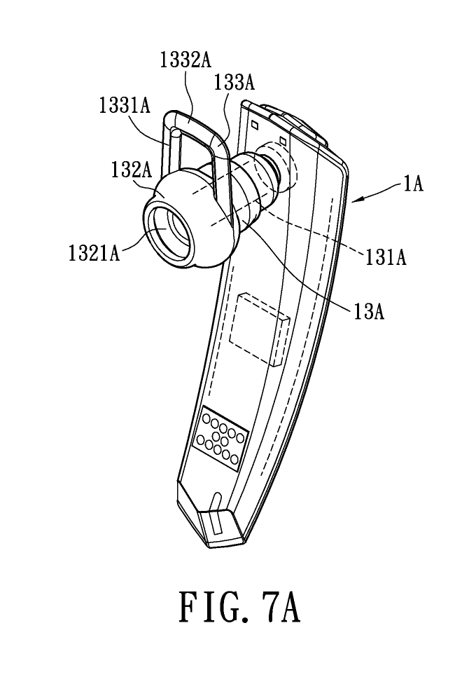

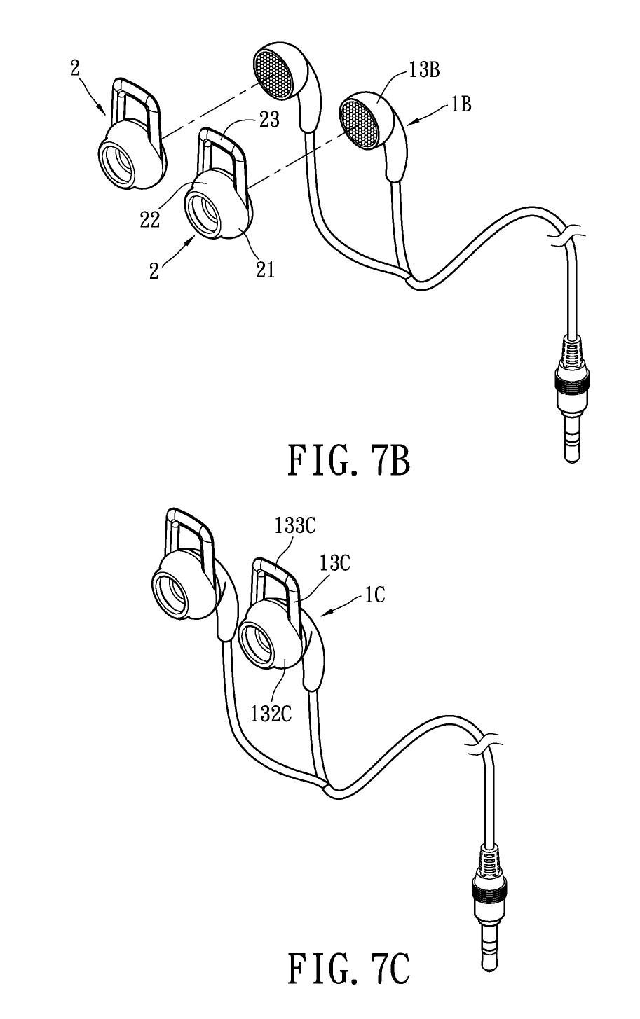

The earphone housing 1 could have different designs shown in FIGS. 7A to 7C. Referring to FIG. 7A, the eighth embodiment of the present invention. The sealed portion 132A and the fixing portion 133A are integrally joined with the holding portion 13A of the earphone housing 1A. The earphone housing 1A disposes a holding portion 13A having a sound passageway 131A, a sealed portion 132A, and a fixing portion 133A. The sealed portion 132A is extended from a face of the holding portion 13A. The fixing portion 133A is extended from a periphery of the holding portion 13A. The sealed portion 132A disposes a sealed space 1321A connected with the sound passageway 131A. The fixing portion 133A has an arm portion 1331A and a jamming portion 1332A. One end of the arm portion 1331A is fixing on holding portion 13A, and the other end of the arm portion 1331A is bent and extended to form the jamming portion 1332A.

Referring to FIG. 7B, the ninth embodiment of the present invention. One end of the earphone housing 1B is extended to form a holding portion 13B correspond to the user's ear canal.

Referring to FIG. 7C, the tenth embodiment of the present invention. One end of earphone housing 1C is extended to form a holding portion 13C correspond to the user's ear canal. The holding portion 13C has a sealed portion 132C and a fixing portion 133C. The sealed portion 132C is extended from a face of the holding portion 13C. The fixing portion 133C is extended from a periphery of the holding portion 13C. The sealed portion 132C and the fixing portion 133C are integrally joined with the holding portion 13C of the earphone housing 1C.

In conclusion, the present invention has following advantages:
1. The sealed portion 22 and the fixing portion 23 can be properly deformed according to the profile of the pinna 32. The earphone housing 1 can be comfortably secured to the user's ear without putting the earplug 2 into the ear canal 31, so as to avoid a tingle and a bacterial infection in the user's ear.
2. The sealed portion 22 fits the pinna 32 outside the ear canal 31 and the fixed portion 23 jams the upper cartilage 321 and the lower cartilage 322 of the pinna 32, so as to constitute a structure of supporting and fixing for making the holding portion 13 not be too loose in the user's ear 3 such that the earplug 2 will not dislodge from user's ear 3.
3. The holding portion 13 is inserted into the sleeved hole 211 and be positioned in the sealed space 221 such that the sealed portion 22 encircles the holding portion 13 for increasing stereo.

The above-mentioned descriptions merely represent solely the preferred embodiments of the present invention, without any intention or ability to limit the scope of the present invention which is fully described only within the following claims. Various equivalent changes, alterations or modifications based on the claims of present invention are all, consequently, viewed as being embraced by the scope of the present invention.

Referring number:

| | |
|---|---|
| [Prior art] | |
| earphone housing | 1a |
| speaker | 11a |
| earplug | 2a |
| [first embodiment] | |
| earphone housing | 1 |
| accommodating space | 11 |
| signal receiver | 12 |
| speaker | 121 |
| holding portion | 13 |
| sound passageway | 131 |
| earplug | 2 |
| sleeving portion | 21 |
| sleeved hole | 211 |
| sealed portion | 22 |
| sealed space | 221 |
| fixing portion | 23, 23A |
| arm portion | 231, 231A |
| jamming portion | 232, 232A |
| abutting portion | 24 |
| ear | 3 |
| ear canal | 31 |
| pinna | 32 |
| upper cartilage | 321 |
| lower cartilage | 322 |
| intertragic | 324 |
| [second embodiment] | |
| fixing portion | 23B |
| arm portion | 231B |
| first arm | 2311B |
| second arm | 2312B |
| jamming portion | 232B |
| [third embodiment] | |
| fixing portion | 23C |
| arm portion | 231C |
| jamming portion | 232C |
| [fourth embodiment] | |
| fixing portion | 23D |
| arm portion | 231D |
| jamming portion | 232D |
| [fifth embodiment] | |
| fixing portion | 23E |
| arm portion | 231E |
| jamming portion | 232E |
| radius of curvature | R |
| [sixth embodiment] | |
| fixing portion | 23F |
| arm portion | 231F |
| jamming portion | 232F |
| [seventh embodiment] | |
| fixing portion | 23G |
| arm portion | 231G |
| jamming portion | 232G |
| ratchet | 2321G |
| [eighth embodiment] | |
| earphone housing | 1A |
| holding portion | 13A |
| sound passageway | 131A |
| sealed portion | 132A |
| sealed space | 1321A |
| fixing portion | 133A |
| arm portion | 1331A |
| jamming portion | 1332A |
| [ninth embodiment] | |
| earphone housing | 1B |
| holding portion | 13B |
| [tenth embodiment] | |
| earphone housing | 1C |
| holding portion | 13C |
| sealed portion | 132C |
| fixing portion | 133C |

What is claimed is:

1. An earphone with a fixing structure, comprising:
an earphone housing having a holding portion, the holding portion formed with a sound passageway for transmitting audible sound; and
an earplug having:
a sleeving portion sleevingly coupleable to the holding portion;
a fixing portion protrudingly extending from a periphery of the sleeving portion, including an arm portion and a jamming portion, wherein the arm portion extended from the sleeving portion and connected with the jamming portion; and
a sealed portion extended from one side of the sleeving portion substantially perpendicular to the fixing portion; and
an abutting portion outwardly protruding from the sleeving portion along a direction substantially opposite to the fixing portion away from a wearer's face and arranged immediately adjacent to the holding portion.

2. The earphone according to claim 1, wherein the sealed portion of earplug is formed with a sealed space therein, the holding portion is inserted into the sleeving portion and positioned in the sealed space.

3. The earphone according to claim 1, wherein the fixing portion further comprises another one arm portion, wherein one ends of the arm portions is fixed on the sleeving portion and parallelly spaced at an interval to each other, wherein the other ends of the arm portions respectively connect the two ends of the jamming portion.

4. The earphone according to claim 1, wherein the fixing portion further comprises another one arm portion, each arm portion having a first arm and a second arm, one end of the first arm being fixed on the sleeving portion and outwardly and slantly extended to form the other end of the first arm, one end of the second arm connecting the other end of the first arm and inwardly and slantly extended to form the other end of the second arm respectively connected with two ends of jamming portion.

5. The earphone according to claim 1, wherein the fixing portion further comprises another one arm portion, one ends of arm portions converging at a point of the sleeving portion and extended radially from the point to form the other ends of arm portions respectively connected with two ends of jamming portion.

6. The earphone according to claim 1, wherein the fixing portion further comprises another one arm portion, one ends of arm portions being fixed on the sleeving portion and spaced at an interval to each other, the other ends of the two arm portions slantly extended along opposite direction to each other and respectively connected with two ends of the jamming portion.

7. The earphone according to claim 1, wherein the arm portion has a radius of curvature, a middle portion of the arm portion being fixed on the sleeving portion and outwardly bent to form two ends of the arm portion respectively connected with two ends of the jamming portion.

8. The earphone according to claim 1, wherein the fixing portion further comprises another one jamming portion, one end of the arm portion being fixed on the sleeving portion and the other end of the arm portion connected with one ends of the two jamming portions.

9. The earphone according to claim 1, wherein the jamming portion includes a plurality of continuous wave-like ratchet structures protrudingly arranged thereon

10. An earphone with fixing function comprising an earphone housing having a signal receiver with a speaker electrically connected to the signal receiver, the earphone characterized in that: the earphone housing comprising:
a holding portion;
a fixing portion extending from a periphery of the holding portion, including an arm portion and a jamming portion,
wherein the arm portion extending from the holding portion and connected with the jamming portion;
an abutting portion (24) outwardly extending away from a wearer's face and arranged immediately adjacent to the holding portion (13), configured to establish abutting contact with a lower cartilage of a wearer's pinna.

11. The earphone according to claim 10, wherein the fixing portion further comprises another one arm portion, one ends of the arm portions being fixed on the sleeving portion and parallelly spaced at an interval to each other, the other ends of the arm portions respectively connected with two ends of the jamming portion.

12. The earphone according to claim 10, wherein the fixing portion further comprises another one arm portion, each arm portion having a first arm and a second arm, one end of the first arm is fixed on the sleeving portion and outwardly and slantly extended to form the other end of the first arm, one end of the second arm connected with the other end of the first arm and inwardly and slantly extended to form the other end of the second arm respectively connected with two ends of jamming portion.

13. The earphone according to claim 10, wherein the fixing portion further comprises another one arm portion, one ends of arm portions converging at a point of the sleeving portion and extended radially from the point to form the other ends of arm portions respectively connected with two ends of jamming portion.

14. The earphone according to claim 10, wherein the fixing portion further comprises another one arm portion, one ends of arm portions being fixed on the sleeving portion and spaced at an interval to each other, the other ends of the two arm portions slantly extended along opposite direction to each other and respectively connected with two ends of the jamming portion.

15. The earphone according to claim 10, wherein the arm portion has a radius of curvature, a middle portion of the arm portion being fixed on the sleeving portion and outwardly bent to form two ends of the arm portion respectively connected with two ends of the jamming portion.

16. The earphone according to claim 10, wherein the fixing portion further comprises another one arm portion, the jamming portion connected with two free ends of the two arm portions, wherein the jamming portion includes a plurality of continuous wave-like ratchet structures protrudingly arranged thereon.

17. An earplug with fixing function, comprising:
a sleeving portion configured to adapt on an ear phone;
a fixing portion extending from a periphery of the sleeving portion, including an arm portion and a jamming portion, wherein the arm portion extended from the sleeving portion and connected with the jamming portion,
wherein the jamming portion includes a plurality of continuous wave-like ratchet structures protrudingly arranged thereon; and
an abutting portion outwardly protruding from the sleeving portion away from a wearer's face configured to establish abutting contact with a lower cartilage of a wearer's pinna, along a direction substantially opposite to the fixing portion.

18. The earplug according to claim 17, wherein the earplug further comprises a sealed portion extended from a face of the sleeving portion and having a sealed space.

19. The earplug according to claim 17, wherein the fixing portion further comprises another one arm portion, one ends of the arm portions being fixed on the sleeving portion and parallelly spaced at an interval to each other, the other ends of the arm portions respectively connected with two ends of the jamming portion.

20. The earplug according to claim 17, wherein the fixing portion further comprises another one arm portion, each arm portion having a first arm and a second arm, one end of the first arm being fixed on the sleeving portion and outwardly and slantly extended to form the other end of the first arm, one end of the second arm connected with the other end of the first arm and inwardly and slantly extended to form the other end of the second arm respectively connected with two ends of jamming portion.

21. The earplug according to claim 17, wherein the fixing portion further comprises another one arm portion, one ends of arm portions converging at a point of the sleeving portion and extended radially from the point to form the other ends of arm portions respectively connected with two ends of jamming portion.

22. The earplug according to claim 17, wherein the fixing portion further comprises another one arm portion, one ends of arm portions being fixed on the sleeving portion and spaced at an interval to each other, the other ends of the two arm portions slantly extended along opposite direction to each other and respectively connected with two ends of the jamming portion.

23. The earplug according to claim 17, wherein the arm portion has a radius of curvature, a middle portion of the arm portion being fixed on the sleeving portion and outwardly bent to form two ends of the arm portion respectively connected with two ends of the jamming portion.

24. The earplug according to claim 17, wherein the fixing portion further comprises another one jamming portion, one end of the arm portion being fixed on the sleeving portion and the other end of the arm portion connected with one ends of the two jamming portions.
